(19) United States
(12) Patent Application Publication
(10) Pub. No.: US 2026/0357920 A1
(43) Pub. Date: Nov. 12, 2026

(54) Systems and Methods for a Control Valve With Integral Relief Valve

(71) Applicant: HUSCO International, Inc., Waukesha, WI (US)

(72) Inventor: David Joyce, Liverpool (GB)

(21) Appl. No.: 19/122,573

(22) PCT Filed: Oct. 23, 2023
(86) PCT No.: PCT/US2023/035734

§ 371 Date: Apr. 18, 2025

Related U.S. Application Data
(60) Provisional application No. 63/418,335, filed on Oct. 21, 2022.

(51) Int. Cl. F15B 13/04; F15B 13/02; F16K 17/04

(52) U.S. Cl. CPC F15B 13/0405; F15B 13/024; F16K 17/048; F15B 2211/50518

(57) ABSTRACT

A control valve includes a poppet assembly with an integral relief valve function. The control valve includes a valve body defining a first port and a second port in communication with a first bore. A main poppet is moveable within the first bore to selectively couple the first port and the second port, and to define a control chamber within the first bore. The main poppet defines a second bore extending through the main poppet to allow fluid to flow from the control chamber to the second port. A relief poppet is moveable within the second bore to selectively couple the control chamber to the second port via the second bore. The relief poppet defines a third bore extending through the first poppet to allow fluid to flow from the control chamber to the second port.

### CROSS-REFERENCES TO RELATED APPLICATIONS

This application claims the benefit of U.S. Provisional Patent Application No. 63/418,335, filed on Oct. 21, 2022, which is incorporated herein by reference in its entirety.

### BACKGROUND

The present disclosure relates generally to hydraulic control assemblies for hydraulic systems. More specifically, the present disclosure relates to systems and methods for thermal relief of a control valve.

### BRIEF SUMMARY

A control valve (e.g., an electrohydraulic proportional valve (EHPV)) can be a two-stage proportional valve with variable restriction to flow, wherein a smaller, solenoid operated pilot stage controls a larger, main poppet, by engaging a pilot seat formed in the main poppet. A relief valve may be a valve which will open at a certain pressure range to allow fluid to pass to a lower pressure chamber. Aspects of the present disclosure provide a system that combines these two functions, by combining the poppet of the relief valve with a seat of the pilot stage of the control valve. Thus, a control valve according to the present disclosure can provide the capability to relive pressure increases due to thermal expansion of fluid in cylinder mounted, load-holding applications.

According to one aspect of the disclosure, a control valve can include a valve body that can define a first bore, a first port and a second port in communication with the first bore, and a first seat between the first port and the second port. A first poppet can be moveably disposed within the first bore to selectively engage and disengage the first seat, and to define a control chamber within the first bore that is opposite the second port. The first poppet can define a second bore that can extend through the first poppet to couple the control chamber to the second port, and a second seat and a third seat formed within the second bore. A second poppet can be moveably disposed within the second bore to selectively engage and disengage the second seat. A first biasing member can extend between the third seat and the second poppet to bias the second poppet into engagement with the second seat.

In some non-limiting examples, the second poppet defines a third bore that can extend through the second poppet. The second poppet can be configured as a check valve that can be moveably disposed within the third bore to selectively engage and disengage a fourth seat, which can be formed within the third bore to allow fluid to flow from the control chamber to the second port. The first biasing member can be configured to retain the check valve within the third bore. In some cases, the control valve can further include a control passage that can extend between the control chamber and the first port. The control passage can be formed in the first poppet.

In some non-limiting examples, when the first poppet is engaged with the first seat, the second poppet can be configured to selectively disengage from the second seat based on a pressure differential between the control chamber and the second port to allow fluid to flow from the control chamber to the second port. When the first poppet is disengaged with the first seat, the second poppet can be configured to engage with the second seat to block fluid flow from the second port to the control chamber. In some cases, the control valve can further include a second biasing member disposed within the first bore. The second biasing member can be configured to bias the first poppet into engagement with the first seat.

In some non-limiting examples, the control valve can further include a third poppet configured to selectively engage and disengage a fifth seat defined by the second poppet to selectively engage and disengage the first poppet with the first seat. When the third poppet is engaged with the fifth seat, the third poppet can block fluid flow from the control chamber to the second port so that a pressure differential between the control chamber and the second port biases the first poppet to engage with the first seat. When the third poppet is disengaged with the fifth seat, fluid can flow from the control chamber to the second chamber so that a pressure in the control chamber reduces and the pressure differential between the control chamber and the second port biases the first poppet to disengage with the first seat. In some cases, an actuator can be configured to move the third poppet to selectively engage and disengage the third poppet with the fifth seat. A third biasing member can be configured to bias the third poppet into engagement with the fifth seat, wherein the actuator can be configured to compress the third biasing member to disengage the third poppet from the fifth seat. The actuator can be configured as a solenoid that includes an armature and a coil, wherein energization of the coil causes the armature to move to compress the third biasing member. The third biasing member can extend between a body of the solenoid and the third poppet, and the third poppet can extend through the armature.

According to another aspect of the disclosure, a control valve can include a valve body that can define a first port and a second port in communication with a first bore. A main poppet can be moveably disposed within the first bore to selectively couple the first port and the second port, and to define a control chamber within the first bore that is opposite the second port and in fluid communication with the first port. The main poppet can define a second bore that can extend through the main poppet to allow fluid to flow from the control chamber to the second port. A relief poppet can be moveably disposed within the second bore to selectively couple the control chamber to the second port via the second bore. The relief poppet can define a third bore that can extend through the first poppet to allow fluid to flow from the control chamber to the second port. A pilot poppet can be moveably disposed in the first bore to selectively couple the control chamber to the second port via the third bore.

In some non-limiting examples, the control valve can further include a check valve disposed within the relief poppet to block fluid flow from the second port to the control chamber. The main poppet can be configured to couple the first port to the second port based on at least one of: a first pressure differential between the control chamber and the second port to allow fluid to flow from the first port to the second port, and a second pressure differential between the first port and the second port to allow fluid to flow from the second port to the first port. The relief poppet can be configured to couple the control chamber to the second port via the second bore based on a pressure differential between the control chamber and the second port when the first port is blocked from the second port by the main poppet. When the pilot poppet moves to couple the control chamber to the second port via the third bore, a pressure differential between the control chamber and the second port moves the main poppet to couple the first port to the second port. In some cases, the control valve can further include an actuator configured to move the pilot poppet to selectively couple the control chamber to the second port via the third bore.

In some non-limiting examples, a first biasing member can be configured to bias the main poppet to block the first port from the second port. The first biasing member can be retained in the control chamber. A second biasing member can be configured to bias the relief poppet to block the control chamber from the second port. The second biasing member can be retained in the second bore. A third biasing member can be configured to bias the pilot poppet to block the control chamber from the second port.

According to another aspect of the disclosure, a control valve can include a valve body that can define a first bore, a first port and a second port in communication with the first bore, and a primary seat between the first port and the second port. A poppet assembly can be moveably disposed within the first bore. The poppet assembly can include a first end configured to engage the primary seat to selectively couple the first port and the second port, a second end configured to defines a control chamber within the first bore that is opposite the second port. A passage can extend between the first end and the second end, and a pilot seat can be formed on the second end between the control chamber and the passage. A pilot poppet can be moveably disposed in the control chamber and can be configured to engage the pilot seat to selectively couple the control chamber to the second port via the passage. The poppet assembly can include a main poppet and a relief poppet. The main poppet can be configured to engage the primary seat and can define a second bore forming the passage and a relief seat within the second bore. The relief poppet can be moveably disposed within the second bore to selectively engage the pilot seat. The relief poppet can define the pilot seat and a third bore forming the passage.

### BRIEF DESCRIPTION OF DRAWINGS

The present disclosure will be better understood and features, aspects, and advantages other than those set forth above will become apparent when consideration is given to the following detailed description thereof. Such detailed description makes reference to the following drawings.

FIG. 1 is a cross-sectional view of a non-limiting example of a valve with integral thermal relief, according to aspects of the disclosure.

FIG. 2 is a detail view of valve of FIG. 1, taken about line II-II.

FIG. 3 is a detail view of the valve of FIG. 1, with a relief poppet configured to provide threshold compensation.

### DETAILED DESCRIPTION

Before any aspects of the present disclosure are explained in detail, it is to be understood that the present disclosure is not limited in its application to the details of construction and the arrangement of components set forth in the following description or illustrated in the following drawings. The present disclosure is capable of other configurations and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

The following discussion is presented to enable a person skilled in the art to make and use aspects of the present disclosure. Various modifications to the illustrated configurations will be readily apparent to those skilled in the art, and the generic principles herein can be applied to other configurations and applications without departing from aspects of the present disclosure. Thus, aspects of the present disclosure are not intended to be limited to configurations shown but are to be accorded the widest scope consistent with the principles and features disclosed herein. The following detailed description is to be read with reference to the figures, in which like elements in different figures have like reference numerals. The figures, which are not necessarily to scale, depict selected configurations and are not intended to limit the scope of the present disclosure. Skilled artisans will recognize the non-limiting examples provided herein have many useful alternatives and fall within the scope of the present disclosure.

Valves can be used to control fluid flow in hydraulic system. In general, a valve can include a control element that can move within a valve body (e.g., a sleeve or valve section) to selectively couple and decouple a first work port from a second work port to control a flow of a fluid therebetween. In some cases, a control element can be moved based on a pressure differential across the control element. For example, pressure within a control chamber of the valve can be modulated to move the control element between a first position that decouples the first and second works ports and a second position that couples the first and second works ports. However, pressure within the control chamber may fluctuate with the temperature of the fluid therein. Accordingly, localized pressure within a control chamber may spike as the fluid heats up (e.g., due to thermal expansion of the fluid). If, for example, the hydraulic system is not operating, or is starting up or shutting down, a flow rate within the valve may be at or near zero, and the fluid in the control chamber may heat up. If the resultant pressure is not relieved, it is possible that the control element can lock or the valve or other components could become damaged.

To prevent such scenarios, a hydraulic system can include a thermal relief valve that can allow a small flow of fluid from the control chamber and provide thermal relief protection. Typically, to provide thermal relief, a valve can be coupled to a separate, external thermal relief valve. However, the increased size and complexity of external thermal relief valves may limit where these types of valves can be used. For example, conventional designs may be difficult to use where the valve is used in a cylinder-mounted application, and more specifically, for load-holding applications where the valve is coupled to a hydraulic actuator via hard piping.

Aspects of the present disclosure can provide improved methods and systems for thermal relief by providing an integral thermal relief valve that is internal to the primary valve. More specifically, a thermal relief valve can be provided with a control element of a valve to allow thermal relief from a control chamber to a work port. For example, an improved poppet assembly can be provided for a valve (e.g., an electrohydraulic proportional valve (EHPV)), which can be configured to relieve localized pressure within a control chamber of the valve that is caused by thermal expansion. In particular, some implementations allow pressure to be relieved internally to the valve through a passage formed in the poppet assembly. Accordingly, the system may provide a method of relieving pressure due thermal expansion within a single valve element. The relief valve may be configured to provide low flow rates to relieve expansion of the fluid, while allowing for relatively generous manufacturing tolerances, enabling a compact, simple device.

For example, a poppet assembly may be movable within a main bore (e.g., a first bore) of the valve body to selectively couple a first port and second port, to control flow between the first and second work ports. Correspondingly, the poppet assembly can at least partially isolate a portion of the main bore to define the control chamber with the main bore (e.g., by engaging and disengaging a first seat form in the valve body). The control chamber can be in fluid communication with the first port, such that the poppet assembly can move based on a pressure differential between the control chamber and the other of the second work port. To provide thermal relief for the control chamber, the poppet assembly can include a main poppet (e.g., a first poppet) that defines a second bore extending through the main poppet from the control chamber to the second work port. Correspondingly, a relief poppet (e.g., a second poppet) may be moveably retained in the second bore to engage and disengage a seat (e.g., a second seat) formed therein. The relief poppet can be biased into engagement with the seat by a biasing member (e.g., a spring or other resilient member) to block flow from the control chamber to the second port during normal operation. However, if pressure rises within the control chamber due to thermal expansion of the fluid, the pressure can act on the relief poppet to overcome the biasing force of the biasing member, which disengages the relief poppet from the second seat and opens the passage between the control chamber to allow fluid to flow from the control chamber to the second port (e.g., around the relief poppet).

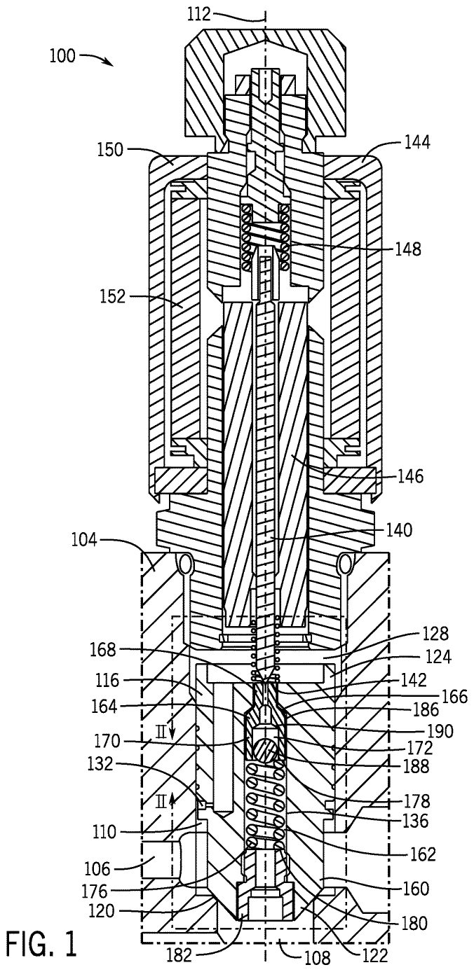

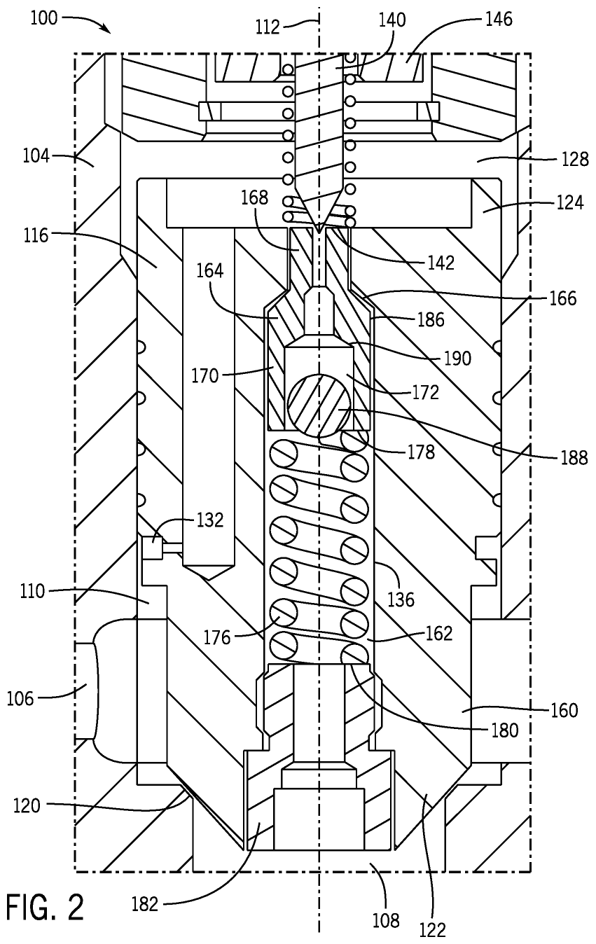

FIGS. 1 and 2 illustrate a non-limiting example of a valve 100 (e.g., control valve) with integral thermal relief, according to aspects of the present disclosure. More specifically, and as will be described in greater detail below, a control element within the valve 100 can include an internal thermal relief valve that is configured to connect various ports or control chambers to relieve pressure due to thermal expansion of the working fluid. Accordingly, the valve 100 can combine the functions of a traditional control valve and a relief valve into a single device. In the illustrated non-limiting example, the valve 100 is configured as a two-stage proportional valve with variable restriction to flow, wherein a smaller solenoid operated pilot stage may control a larger poppet. However, the principles described herein can also be applied to other types of control valves.

In general, the valve 100 includes a valve body 104 that defines one or more ports (e.g., work ports, tank ports, pump ports, etc.), which can be selectively coupled and decoupled to control fluid flow within a hydraulic system. In some non-limiting examples, the valve body 104 can be part of (e.g., integral with) a valve section, such that any components of the valve 100 are directly installed into the valve section. In other non-limiting examples, the valve body 104 can be configured as a valve sleeve that is received within a valve section, allowing the entire control valve to be more easily replaced.

In the illustrated non-limiting example, the valve body 104 defines a first port 106 (e.g., a first work port) and a second port 108 (e.g., a second work port). Here, the first port 106 is a side port that is provided in a side of the valve body 104, and the second port 108 is a nose port that is provided at an end of the valve body 104 (e.g., a nose of the valve body). Within the valve body 104, the valve 100 can define a main bore 110 (e.g., a first bore) extending along an axis 112 of the valve body 104. The first port 106 and the second port 108 can be in communication with one another, such that fluid can flow between the first port 106 and the second port 108 via the main bore 110. Here, the first port 106 is axially aligned with the main bore 110 and the second port is radially aligned with the main bore 110. In other non-limiting examples, ports may be arranged differently, and more than two ports may be included.

As generally discussed above, a control valve can include a control element that is configured to selectively couple two or more ports. More specifically, the control element can be movably disposed within a bore of a valve body to selectively couple the ports. In the illustrated non-limiting example, the valve 100 includes a control element configured as a poppet assembly 116. The poppet assembly 116 can be movably disposed within the main bore 110 to selectively couple the first port 106 and the second port 108. More specifically, the poppet assembly 116 can move along the axis 112, relative to a main seat 120 (e.g., a first or primary seat) defined by the valve body 104. As illustrated, the main seat 120 can be positioned within the main bore 110, between the first port 106 and the second port 108. Correspondingly, the poppet assembly 116 can define a first end 122 and a second end 124 that is opposite the first end 122. The poppet assembly 116 can move between a first position where the first end engages the main seat 120 to decouple the first port 106 from the second port 108, and a second position where the first end disengages the main seat 120 to couple the first port 106 to the second port 108 and allow fluid flow therebetween.

In some cases, a control element can be configured to move to selectively couple ports based on a pressure of the fluid within the valve. That is, the control element can be a pilot operated control element, in which a pilot poppet can be operated to control a pressure within a control chamber. In the illustrated non-limiting example, the poppet assembly 116 is configured to move based on a pressure within a control chamber 128 defined within the main bore 110. More specifically, the poppet assembly 116 is configured to at least partially isolate a region of the main bore 110 (e.g., at the second end 124 of the poppet assembly) to define the control chamber 128 within the main bore 110. Accordingly, the control chamber 128 can be collectively defined by the sides of the main bore 110 and the second end 124 of the poppet assembly 116.

As illustrated, the second port 108 is located at the first end 122 of the poppet assembly 116 and the control chamber 128 is located at the second end 124 of the poppet assembly 116. Accordingly, the poppet assembly 116 can move based on a pressure differential between the control chamber 128 and the first port 106 and the second port 108. The force balance on the poppet assembly 116 is a result of the pressure acting on the second end 124 of the poppet assembly 116 multiplied by the area of the full diameter of the poppet assembly 116 (e.g., the pressure in the control chamber 128 that acts to move the poppet assembly 116 to the first position to engage the main seat and close the valve 100), versus the pressure at the first port 106 multiplied by the annulus area (e.g., the area of the full diameter of the poppet assembly minus the area of the seat diameter) plus the pressure at the second port 108 multiplied by the area of the diameter of the main seat 120 (e.g., the pressure from the first port 106 and the second port 108 acting together move the poppet assembly 116 to the second position to disengage the main seat 120 and open the valve 100).

Correspondingly, pressure can be provided to a control chamber from one of the ports and relieved to another of the ports to move a poppet assembly. In the illustrated non-limiting example, the control chamber 128 is coupled to the first port 106 via an orifice 132, such that fluid and pressure is communicated from the first port 106 to the control chamber 128. The orifice 132 is provided in the poppet assembly 116, but may alternatively be provided in another component, for example, the valve body 104. To relieve pressure within the control chamber 128, the poppet assembly 116 can define a passage 136 (e.g., a relief passage) that extends through the poppet assembly 116 (e.g., from the first end 122 to the second end 124) to couple the control chamber 128 to the second port 108.

By selectively blocking the passage 136, the pressure within the control chamber 128 can be modulated to control movement of the poppet assembly 116. For example, by blocking the passage 136 to decouple the control chamber 128 from the second port 108, fluid can flow into the control chamber 128 from the first port 106 to build pressure within the control chamber 128 and bias the poppet assembly 116 to the first position (e.g., to engage the main seat 120 and decouple the first port 106 and the second port 108). However, by opening the passage 136 to couple the control chamber 128 from the second port 108, fluid can flow from the control chamber 128 to the second port. Since passage 136 is configured to have a smaller pressure drop than the orifice 132 (e.g., with a larger cross-sectional area the orifice 132), fluid can flow out of the passage 136 faster than it is provided by the orifice 132 and the control chamber 128 will drain so that the pressure therein reduces. Accordingly, pressure at the first end 122 (e.g., from the first port 106 and the second port 108) will bias the poppet assembly 116 to the second position (e.g., to disengage the main seat 120 and couple the first port 106 and the second port 108).

As generally mentioned above, a pilot poppet 140 can be provided to selectively couple the control chamber 128 to the second port 108 (e.g., to selectively open or block the passage 136). As illustrated, the pilot poppet 140 is movably disposed within the main bore 110 to engage and disengage a pilot seat 142 formed in the second end 124 of the poppet assembly 116 (e.g., to move along the axis between a first, engaged position and a second, disengaged position). When engaged with the pilot seat 142, the pilot poppet 140 blocks the passage 136 to decouple the control chamber 128 from the second port 108. When disengaged with the pilot seat 142, the pilot poppet opens the passage 136 to couple the control chamber 128 to the second port 108.

In some cases, a pilot poppet can be operated (e.g., moved) by an actuator. In the illustrated non-limiting example, the pilot poppet 140 is a solenoid-operated pilot poppet. Accordingly, the valve 100 can include a solenoid 144 that is coupled to the valve body 104 to move the pilot poppet 140. In this case, the pilot poppet 140 is coupled to an armature 146 of the solenoid 144 and is biased to engage the pilot seat 142 by a pilot spring 148 (or another type of biasing member) that is configured to push the pilot poppet 140 toward the pilot seat 142. Here, the pilot spring 148 is positioned between the armature 146 and a body 150 of the solenoid 144; however, other spring arrangements may also be used. Accordingly, when an electric current is applied to a coil 152 of the solenoid 144, the armature 146 is moved to compress the pilot spring 148, which reduces the force on the pilot poppet 140. Once the magnetically induced force overcomes the spring load, the pilot poppet 140 can begin to move out of engagement with the pilot seat 142, enabling a flow path of fluid from the control chamber 128, through the pilot seat 142 and out of the second port 108. Correspondingly, when the coil 152 is deactivated, the magnetic force on the armature 146 is removed so that the spring force from the pilot spring 148 returns the armature 146 and pilot poppet 140 into engagement with the pilot seat 142.

In some cases, particularly, when the poppet assembly 116 is engaged with the main seat 120 to block the first port 106 and the second port 108 and little to no fluid is passing through the valve 100, heating of the fluid within the control chamber 128 can result in thermal expansion of the fluid and a corresponding spike in pressure. To prevent an overpressure condition within the valve 100 due to thermal expansion, the poppet assembly 116 can be configured with an integral relief valve. A relief valve is a valve that opens at a predetermined pressure range to allow fluid to pass from a control chamber to a lower pressure area.

According to the present disclosure, a relief valve can be configured as a relief poppet that is provided within a larger, main poppet (e.g., a main control element). The relief poppet can be configured to make hard contact with an outer seat in the main poppet under normal operation and temperature conditions and to move away from the seat to relief pressure from thermal expansion. In some cases, the relief poppet may be biased to engage the seat by a biasing member (e.g., a spring or other resilient member). Still referring to FIGS. 1 and 2, the poppet assembly 116 can include a main poppet 160 moveably disposed in the main bore 110 and configured to selectively couple the first port 106 and the second port 108, and which defines the control chamber 128 within the main bore 110. Correspondingly, the main poppet 160 defines the first end 122 and the second end 124, as well as the orifice 132. Additionally, the main poppet 160 defines a second bore 162 that forms at least a portion of the passage 136, such that the second bore 162 may be at least partially coextensive with the passage 136. In other non-limiting examples, the second bore 162 may be separate from the passage 136.

To provide pressure relief due to thermal expansion, a relief poppet 164 can be moveably disposed within the second bore 162. More specifically, the relief poppet 164 can move within the second bore 162 to selectively engage and a disengage a relief seat 166 (e.g., a second seat) that is defined within the second bore 162. As illustrated, the relief poppet 164 defines a first end 168 configured to engage with the relief seat 166, and a second end 170 that is opposite the first end 168. Additionally, in the illustrated non-limiting example, the relief poppet 164 defines a third bore 172 that extends through the relief poppet 164 from the first end 168 to the second end 170, The third bore 172 forms at least a portion of the passage 136, such that the third bore 172 may be at least partially coextensive with the passage 136. In some cases, when the first end 168 is engaged with the relief seat 166, the first end 168 of the relief poppet 164 can be configured to form the pilot seat 142. The portion of the first end 168 that forms the pilot seat 142 can be exposed to at least partially define the control chamber 128. In particular, when the pilot poppet 140 disengages the pilot seat 142 (e.g., the relief poppet 164), fluid can drain through the third bore 172 and the second bore 162 to vent to the second port 108. In other non-limiting examples, in particular, where the second bore 162 does not form part of the passage 136, the relief poppet 164 may be configured differently. For example, a relief poppet may not include a third bore.

In some cases, a relief poppet can be configured as a spring-biased and normally closed poppet. For example, in the illustrated non-limiting example, a biasing member configured at a relief spring 176 is disposed with in the second bore 162 and configured to bias the relief poppet 164 into engagement with the relief seat 166. The relief spring 176 is positioned to extend between the relief poppet 164 and the second port 108. More specifically, the relief spring 176 extends between the second end 170 of the relief poppet 164, which forms a first spring seat 178, and a second spring seat 180 that is formed within the second bore 162. In this case, the second spring seat 180 is formed proximate the first end of the main poppet 160 (e.g., the poppet assembly 116). As illustrated, in some non-limiting examples, the second spring seat 180 may be formed by a retainer 182 (e.g., a spring retainer) that is configured to couple to the main poppet 160. For example, the retainer 182 can be configured to be releasably or non-releasably received within the second bore 162 (e.g., via a threaded, press-fit, or other type of connection). In this way, the relief poppet 164 and the relief spring 176 can be installed and retained within the second bore 162. Additionally, the retainer 182 can be fixed, or it can be adjustable (e.g., with a locknut arrangement), such that the position of the second spring seat 180 relative to the first spring seat 178 can be adjustable (e.g., to adjust a cracking pressure of the relief poppet 164).

Relatedly, when retained in the second bore 162, the relief spring 176 may be pre-compressed to control a cracking pressure of the relief valve function. That is, the relief spring 176 and relief poppet 164 can be configured so that the relief poppet 164 disengages from the relief seat 166 at a predetermined cracking pressure (e.g., a pressure differential between the control chamber 128 and second port 108). The cracking pressure is a function of the area of the relief poppet 164 that is exposed to the control chamber 128 and the pre-load of the relief spring 176 (e.g., a spring force of the relief spring 176). When the pressure differential between the control chamber 128 and the second port 108 reaches or exceeds the cracking pressure, the fluid pressure acting on the first end 168 of the relief poppet 164 (e.g., from the control chamber 128) can overcome the pre-load on the relief spring 176 plus the pressure acting on the second end 170 of the relief poppet 164 (e.g., from the second port 108). This causes the relief poppet 164 to disengage the relief seat 166 and further compress the relief spring 176. As the relief poppet 164 moves away from the relief seat 166 (e.g., along the axis 112), fluid from the control chamber 128 can flow around the relief poppet 164 within the second bore 162, thereby reducing the pressure in the control chamber 128. Correspondingly, the second bore or the relief valve can be configured to allow flow around the relief poppet 164. For example, the relief poppet 164 may define one or more channels 186 in its exterior surface that act as flow channels, or the second bore 162 can define a region of increase cross-sectional area that allows flow to go around the relief poppet 164.

In some non-limiting examples, a valve according to the present disclosure can be configured to allow bi-directional flow between a first port and a second port. However, when pressure in the second port is greater that the pressure in the first port, the control chamber will be connected to the second port when the pilot poppet is disengaged from the pilot seat. This may allow flow from the second port to the control chamber, which may raise the pressure in the control chamber 128 to that of the second port 108. As a result, the pressure in the control chamber 128 may bias the poppet assembly 116 to remain closed (e.g., to engage the main seat 120). In such cases, flow may be limited to pass from the second port 108, through the pilot seat 142 and across the orifice 132 to the first port 106, which may lead to very restricted flow in this direction. Correspondingly, it can be desirable to prevent backflow from the second port 108 to the control chamber 128, such that the pressure in the control chamber 128 is determined by the pressure in the first port 106. To prevent backflow from the second port 108 to the control chamber 128, a check valve 188 can be provided within the passage 136 to allow unidirectional flow from control chamber 128 to the second port 108.

In the illustrated non-limiting example, the check valve 188 is disposed within the third bore 172 of the relief poppet 164, where it can be retained by the relief spring 176. Accordingly, the third bore 172 can define a seat 190 therein and the check valve 188 can move within the third bore 172 to selectively engage and disengage the seat 190 based on a pressure differential between the second port 108 and the control chamber 128. Accordingly, when fluid flows from the first port 106 to the second port 108, the check valve 188 disengages the seat 190 to allow flow through the relief poppet 164 (e.g., the poppet assembly 116). Conversely, when fluid flows from the second port 108 to the first port 106, the check valve 188 engages the seat 190 to block flow through the relief poppet 164.

As generally discussed above, the valve 100 can be operable between a variety of configurations to control flow through the valve 100. In a first configuration (e.g., a closed configuration), the valve 100 can be configured to decouple the first port 106 from the second port 108, and to decouple the control chamber 128 from the second port 108. In the first configuration, the poppet assembly 116 is closed with the main poppet 160 engaged with the main seat 120 and the relief poppet 164 engaged with the relief seat 166. In this way, the main poppet 160 blocks flow between the first port 106 and the second port 108, and the relief poppet 164 blocks flow from the control chamber 128 to the second port 108 through the second bore 162 of the main poppet 160 (e.g., around the relief poppet 164 and through the relief seat 166). Additionally, the pilot poppet 140 is engaged with the pilot seat 142 to block flow from the control chamber 128 to the second port 108 through the third bore 172.

To place the valve 100 in the first configuration, the solenoid 144 can be deenergized so that the pilot spring 148 biases the pilot poppet 140 engage with the pilot seat 142. This blocks the third bore 172 to prevent fluid from passing out of the control chamber 128. Because the control chamber 128 remains coupled to the first port 106 via the orifice 132, fluid will continue to flow into the control chamber 128 from the first port 106. This causes an increase in pressure within the control chamber 128. With respect to the main poppet 160, once the force associated with the pressure in the control chamber 128 (e.g., the force at the second end 124) overcomes the force associated with the pressure at the first port 106 and the second port 108 (e.g., the force at the first end 122), the poppet assembly 116 is forced into engagement with the main seat 120. Accordingly, the poppet assembly 116 can move within the main bore 110 to engage with the main seat 120 (e.g., along the axis 112). Additionally, respect to the relief poppet 164, it is appreciated the force provided by the relief spring 176 (e.g., the force at the second end 170) may overcome the force associated with the pressure in the control chamber 128 (e.g., the force at the first end 168), which forces the relief poppet 164 into engagement with the relief seat 166. Accordingly, the relief poppet 164 can move within the second bore 162 to engage the relief seat 166 (e.g., along the axis 112, relative the main poppet 160).

In a second configuration (e.g., an open configuration), the valve 100 can be configured to couple the first port 106 to the second port 108, and to couple the control chamber 128 to the second port 108. In the second configuration, the poppet assembly 116 is in a first open configuration, with the main poppet 160 disengaged from the main seat 120 and the relief poppet 164 engaged with the relief seat 166. In this way, the main poppet 160 allows flow between the first port 106 and the second port 108, and the relief poppet 164 blocks flow from the control chamber 128 to the second port 108 through the second bore 162 of the main poppet 160 (e.g., around the relief poppet 164 and through the relief seat 166). Additionally, the pilot poppet 140 is disengaged from the pilot seat 142 to allow flow from the control chamber 128 to the second port 108 through the third bore 172.

To place the valve 100 in the second configuration, the solenoid 144 can be energized so that the pilot spring 148 is compressed and the pilot poppet 140 disengages from the pilot seat 142. This opens the third bore 172 to allow fluid to pass out of the control chamber 128 to the second port 108. Because fluid in the control chamber 128 can drain through the third bore 172 at faster rate than fluid can flow into the control chamber 128 through the orifice 132, the amount of fluid in the control chamber 128 will decrease. This causes a decrease in pressure within the control chamber 128. With respect to the main poppet 160, once the force associated with the pressure at the first port 106 and the second port 108 (e.g., the force at the first end 122) overcomes the force associated with the pressure in the control chamber 128 (e.g., the force at the second end 124), the poppet assembly 116 is disengaged from the main seat 120. Accordingly, the poppet assembly 116 can move within the main bore 110 to disengage from the main seat 120 (e.g., along the axis 112). Additionally, with respect to the relief poppet 164, it is appreciated the force provided by the relief spring 176 (e.g., the force at the second end 170) may overcome the force associated with the pressure in the control chamber 128 (e.g., the force at the first end 168), which forces the relief poppet 164 into engagement with the relief seat 166. Accordingly, the relief poppet 164 can move within the second bore 162 to engage the relief seat 166 (e.g., along the axis 112, relative the main poppet 160). Moreover, in non-limiting examples that include the check valve 188, the check valve 188 may be disengaged with the seat 190 when fluid flows from the first port 106 to the second port 108 and engaged the seat 190 when fluid flows from the second port 108 to the first port 106.

In a third configuration (e.g., a relief configuration), the valve 100 can be configured to provide thermal relief. The third configuration may be similar to the first configuration, but with the relief poppet 164 disengaged from the relief seat 166 to allow a small flow of fluid to drain from the control chamber 128 to the second port 108 to provide thermal relief (e.g., an overpressure condition due to thermal expansion of the fluid). The first port 106 and second port 108 can remain decoupled by the main poppet 160 to prevent flow therebetween.

Accordingly, in the third configuration, the valve 100 can be configured to decouple the first port 106 from the second port 108, and to couple the control chamber 128 to the second port 108. In the second configuration, the poppet assembly 116 is in a second open configuration, with the main poppet 160 engaged with the main seat 120 and the relief poppet 164 disengaged from the relief seat 166. In this way, the main poppet 160 blocks flow between the first port 106 and the second port 108, and the relief poppet 164 allows flow from the control chamber 128 to the second port 108 through the second bore 162 of the main poppet 160 (e.g., around the relief poppet 164 and through the relief seat 166). As the relief poppet 164 moves away from the relief seat 166, the pilot poppet 140 may remain engaged with the pilot seat 142 to block flow from the control chamber 128 to the second port 108 through the third bore 172. For example, the preload on the pilot spring 140 can act to move the pilot poppet 140 to follow the movement of the relief poppet 164 so that the pilot poppet 140 remains engaged with the pilot seat 142.

To place the valve 100 in the third configuration, the solenoid 144 can be deenergized so that the pilot spring 148 biases the pilot poppet 140 engage with the pilot seat 142. This blocks the third bore 172 to prevent fluid from passing out of the control chamber 128 therethrough. Similar to the first configuration, this forces the poppet assembly to engage the main seat 120. Because the control chamber 128 remains coupled to the first port 106 via the orifice 132, fluid will remain within the control chamber 128. The fluid within the control chamber 128 may increase in temperature (e.g., due to heat transfer from the surrounding environment), which can result in expansion of the fluid therein. This thermal expansion can cause a corresponding increase in pressure within the control chamber 128. Because the main poppet 160 is engaged with the main seat 120 to block the first port 106 from the second port 108 and the pilot poppet 140 is engage with the pilot seat 142 to block the third bore 172, fluid cannot relieve along these paths to reduce the pressure in the control chamber 128. Accordingly, once the pressure differential between the control chamber 128 and the second port 108 reaches or exceeds the cracking pressure, such that the force associated with the pressure in the control chamber 128 acting on the first end 168 of the relief poppet 164 overcomes the force associated with the relief spring 176 acting on the second end 170 of the relief poppet 164, the relief poppet 164 can disengage with the relief seat 166. Accordingly, the relief poppet 164 can move within the second bore 162 (e.g., along the axis 112), allowing fluid to flow through the relief seat 166 and around the relief poppet 164 through the second bore 162 to the second port 108. The movement of the relief poppet 164 compresses the relief spring 176. Accordingly, once the pressure differential between the control chamber 128 and the second port 108 drops below the cracking pressure, the force of the compressed relief spring 176 again overcome the force due to pressure from the control chamber 128 to move the relief poppet 164 back into engagement with the relief seat 166, such that the first configuration is reattained.

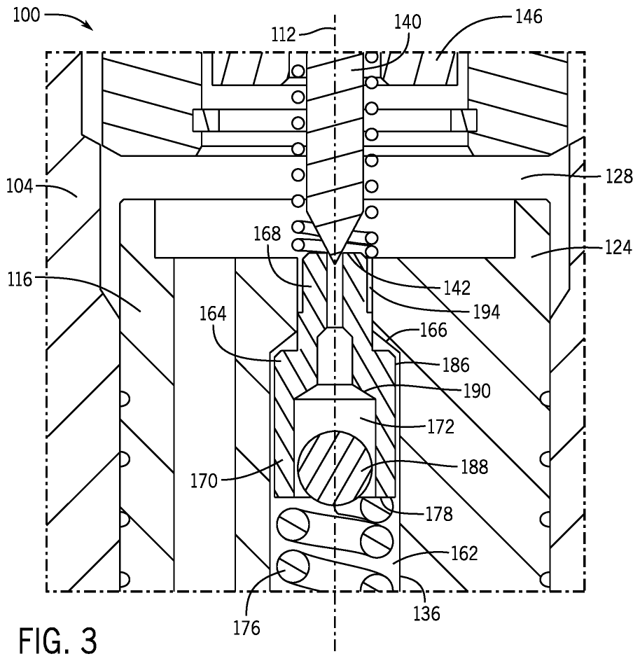

Referring now to FIG. 3, a relief poppet can be configured to provide threshold compensation, wherein the relief poppet can move some distance away from a relief seat before opening a connection between a control chamber and port. For example, the relief poppet 164 can include one or more notches 194 formed at the first end 168 of the relief poppet 164. The notches 194 may extend partially along the length of the relief poppet 164 from the first end 168 to the second end 170. Additionally, the relief poppet 164 and second bore 162 can be configured to provide sealing at the notches 194 (e.g., partial sealing), such that the relief poppet 164 can move a predetermined distance out of engagement with the relief seat 166 before the notches 194 become exposed (e.g., uncovered) to allow flow from the control chamber 128 to the second port 108. Correspondingly, the spring rate of the relief spring 176 can be configured to provide compensation motion in conjunction with the size (e.g., diameter) of the relief poppet 164.

Accordingly, as the pressure in the control chamber 128 increases (e.g., due to thermal expansion), but before the cracking pressure is reached, the pressure in the control chamber 128 can act on the area of the notches 194 (e.g., a diameter of the relief poppet 164 at the location of the notches 194) to begin moving the relief poppet 164 out of engagement with the relief seat 166. During this initial movement, the notches 194 remain covered to block flow from the control chamber 128, although, there may be some leakage due to manufacturing tolerances necessary to allow movement of the relief poppet 164 in the second bore 162. Additionally, this initial movement can unload some or all of the preload on the pilot spring 148. Unloading the pilot spring 148 can offset the increased force holding the pilot poppet 140 on the pilot seat 142 that is caused by the increased pressure in the control chamber 128. Then, once the cracking pressure is reached, the relief poppet 164 is moved further from the relief seat 166 to open the notches 194 and couple the control chamber 128 to the second port 108 to provide thermal relief (e.g., in the third configuration), as generally discussed above.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Thus, while the invention has been described in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

1. A control valve comprising:
a valve body defining a first bore, a first port and a second port in communication with the first bore, and a first seat between the first port and the second port;
a first poppet moveably disposed within the first bore to selectively engage and disengage the first seat, and to define a control chamber within the first bore that is opposite the second port, the first poppet defining a second bore extending through the first poppet to couple the control chamber to the second port, and a second seat and a third seat formed within the second bore;
a second poppet moveably disposed within the second bore to selectively engage and disengage the second seat, wherein the pressure in the control chamber biases the second poppet to disengage with the second seat; and
a first biasing member extending between the third seat and the second poppet to bias the second poppet into engagement with the second seat.

2. The control valve of claim 1, wherein the second poppet defines a third bore extending through the second poppet.

3. The control valve of claim 2 further comprising a check valve that is moveably disposed within the third bore to selectively engage and disengage a fourth seat that is formed within the third bore to allow fluid to flow from the control chamber to the second port.

4. The control valve of claim 2, wherein the first biasing member is configured to retain the check valve within the third bore.

5. The control valve of claim 1, further including a control passage extending between the control chamber and the first port.

6. The control valve of claim 5, wherein the control passage is formed in the first poppet.

7. The control valve of claim 1, wherein, when the first poppet is engaged with the first seat, the second poppet is configured to selectively disengage from the second seat based on a pressure differential between the control chamber and the second port to allow fluid to flow from the control chamber to the second port.

8. The control valve of claim 1, wherein, when the first poppet is disengaged with the first seat, the second poppet is configured to engage with the second seat to block fluid flow from the second port to the control chamber.

9. The control valve of claim 1, further comprising a second biasing member disposed within the first bore and configured to bias the first poppet into engagement with the first seat.

10. The control valve of claim 1, further comprising a third poppet configured to selectively engage and disengage a fifth seat defined by the second poppet to selectively engage and disengage the first poppet with the first seat,
wherein, when the third poppet is engaged with the fifth seat, the third poppet blocks fluid flow from the control chamber to the second port so that a pressure differential between the control chamber and the second port biases the first poppet to engage with the first seat, and
wherein, when the third poppet is disengaged with the fifth seat, fluid flows from the control chamber to the second port so that a pressure in the control chamber reduces and the pressure differential between the control chamber and the second port biases the first poppet to disengage with the first seat.

11. The control valve of claim 10 further comprising an actuator configured to move the third poppet to selectively engage and disengage the third poppet with the fifth seat.

12. The control valve of claim 11 further comprising a third biasing member configured to bias the third poppet into engagement with the fifth seat, wherein the actuator is configured to compress the third biasing member to disengage the third poppet from the fifth seat.

13. The control valve of claim 12, wherein the actuator is configured as a solenoid that includes an armature and a coil, wherein energization of the coil causes the armature to move to compress the third biasing member.

14. The control valve of claim 13, wherein the third biasing member extends between a body of the solenoid and the third poppet, and
wherein the third poppet extends through the armature.

15. A control valve comprising:
a valve body defining a first port and a second port in communication with a first bore;
a main poppet moveably disposed within the first bore to selectively couple the first port and the second port, and to define a control chamber within the first bore that is opposite the second port and in fluid communication with the first port, the main poppet defining a second bore extending through the main poppet to allow fluid to flow from the control chamber to the second port;
a relief poppet moveably disposed within the second bore to selectively couple the control chamber to the second port via the second bore, the relief poppet defining a third bore extending through the main poppet to allow fluid to flow from the control chamber to the second port; and
a pilot poppet moveably disposed in the first bore to selectively couple the control chamber to the second port via the third bore.

16. The control valve of claim 15 further comprising a check valve disposed within the relief poppet to block fluid flow from the second port to the control chamber.

17. The control valve of claim 15, wherein the main poppet is configured to couple the first port to the second port based on at least one of:
a first pressure differential between the control chamber and the second port to allow fluid to flow from the first port to the second port; and
a second pressure differential between the first port and the second port to allow fluid to flow from the second port to the first port.

18. The control valve of claim 1, wherein the relief poppet is configured to couple the control chamber to the second port via the second bore based on a pressure differential between the control chamber and the second port when the first port is blocked from the second port by the main poppet.

19. The control valve of claim 1, wherein, when the pilot poppet moves to couple the control chamber to the second port via the third bore, a pressure differential between the control chamber and the second port moves the main poppet to couple the first port to the second port.

20. The control valve of claim 15, further comprising an actuator configured to move the pilot poppet to selectively couple the control chamber to the second port via the third bore.

21. The control valve of claim 1 further comprising:
a first biasing member configured to bias the main poppet to block the first port from the second port;
a second biasing member configured to bias the relief poppet to block the control chamber from the second port; and
a third biasing member configured to bias the pilot poppet to block the control chamber from the second port.

22. The control valve of claim 21, wherein the first biasing member is retained in the control chamber and the second biasing member is retained in the second bore.

23. A control valve, comprising:
a valve body defining a first bore, a first port and a second port in communication with the first bore, and a primary seat between the first port and the second port;
a poppet assembly moveably disposed within the first bore, the poppet assembly including a first end configured to engage the primary seat to selectively couple the first port and the second port, a second end configured to defines a control chamber within the first bore that is opposite the second port, and a passage extending between the first end and the second end, wherein a pilot seat is formed on the second end between the control chamber and the passage; and a pilot poppet moveably disposed in the control chamber and configured to engage the pilot seat to selectively couple the control chamber to the second port via the passage; and
wherein the poppet assembly includes:
a main poppet configured to engage the primary seat and defining a second bore forming the passage and a relief seat within the second bore; and
a relief poppet moveably disposed within the second bore to selectively engage the pilot seat, the relief poppet defining the pilot seat and a third bore forming the passage.
